(19) United States
(12) Patent Application Publication
(10) Pub. No.: US 2007/0083440 A1
(43) Pub. Date: Apr. 12, 2007

(54) Method, system and computer program product for secure electronic purchasing from a plurality of merchants on a common web site

(76) Inventors: Joseph G. Wirtz, Menomonee Falls, WI (US); John L. Bendler, Milwaukee, WI (US)

Correspondence Address: SEYFARTH SHAW LLP, 131 S. DEARBORN ST., SUITE2400, CHICAGO, IL, 60603-5803, US

(21) Appl. No.: 11/634,438

(22) Filed: Dec. 6, 2006

Related U.S. Application Data
(62) Division of application No. 09/636,031, filed on Aug. 11, 2000.

(51) Int. Cl. G06Q 30/00

(52) U.S. Cl. 705/26

(57) ABSTRACT

An electronic advertising and purchasing system and method is implemented in a global computer network to enable a consumer to purchase or gain additional information about advertised goods or services while the consumer remains connected to a hosting web site. The hosting server includes a sessions manager that sends instructions to a plurality of consumer workstations to display a web page from the hosting web site. The hosting server also includes an ad generator to send a banner applet to the consumer workstations to promote one or more goods or services in banners on the web page. The banners contain links that sends a request to the banner applet for additional product information, or for an order form to permit the consumer to purchase the advertised goods or services. The banner applet provides data to the consumer workstations without causing the workstations to query the hosting server, or terminate, or suspend their active sessions with the sessions manager. Thus, the consumer remains connected to the hosting web site while the consumer places electronic orders.

### PRIORITY CLAIM

This application is a divisional application of, claims priority to and the benefit of U.S. patent application Ser. No. 09/636,031 filed Aug. 11, 2000, the entire contents of which are incorporated herein.

### BACKGROUND OF THE INVENTION

1. Field of the Invention

The present invention relates generally to electronic commercial transactions, and more specifically, to a system, method and computer program product for purchasing goods and services over a computer network.

2. Related Art

Global computer networks have quickly become cost-effective and reliable mediums for the exchange and management of information within an extensive array of computers and smaller computer networks. The computer networks vary in size and type such as, local internets, corporate intranets, local area networks (LAN), wide area networks (WAN), private enterprise networks, and the like. The Internet is the most commonly known global computer network.

The evolution of global computer networks and supporting technologies have made it possible for government officials, educational institutions, businesses, nonprofit organizations, and individuals to communicate with the local networks or personal computers of other persons or organizations. Many businesses, for instance, have been able to established web sites or home pages to promote, sell, and distribute their products (e.g., goods and services). Therefore, a web user browsing the merchant's web site can order the product directly from the merchant's web site. For example, U.S. Pat. No. 5,960,411 to Hartman et al. describes a network system for placing orders over the Internet. In the system of Hartman et al., products are advertised to a consumer from a merchant's server. The consumer can purchase the product by sending a purchase request back to the merchant's server.

However, it is also commonplace for businesses to place advertisements on other individuals or entities' web sites to promote their products. The other web site owner can be an authorized distributor, retailer, or affiliate who has agreed to promote the merchant's advertisement. Typically, when a web user activates or clicks on the merchant's banner, the user is taken to the merchant's web site where the user can purchase the advertised good or service. In other words, the banner is actually a hyperlink to the merchant's web site.

U.S. Pat. No. 5,909,492 to Payne et al. describes a network-based sales system for electronic procurements. In the system of Payne et al., a buyer computer is interconnected a merchant computer and purchase computer over the Internet. The merchant computer routes an advertised product to the buyer computer. If interested, a consumer can use the buyer computer to order the product by sending a request to the purchase computer. Therefore, in the system of Payne et al., the consumer must discontinue the browsing session with the merchant computer to initiate another session to purchase the product from the purchase computer.

U.S. Pat. No. 5,970,472 to Allsop et al. describes a similar network purchasing system; however, the consumer is directed to an authorized dealer's web site. In this system, a manufacturer advertises various products on its web site. The advertisements serve as hyperlinks to the authorized dealer's web site where the consumer can purchase the product. The consumer's connection to the manufacture's web site is terminated when the user is directed to the dealer's web site.

Another example of an advertisement system that directs consumers to the web site of a merchant can be seen in U.S. Pat. No. 5,948,061 to Merriman et al. In this system, a consumer can browse the web page of an affiliate of a vendor. The affiliate's web page contains advertisements from the vendor's server. If the consumer decides to respond to the advertisement, the consumer is connected to the vendor's server or web site.

U.S. Pat. No. 6,029,141 to Bezos et al. describes another Internet-based referral system that enables individuals and other business entities to market products sold from a merchants web site. The system includes hypertextual referral links that allows a consumer to link to the merchant's site to purchase the products. Thus, the consumer would have to leave the web site of the hosting individuals or other business entities.

As described in the aforementioned patents, conventional electronic commerce network systems require a consumer to connect to the server of a merchant in order to purchase the merchants products. The merchant includes the manufacturer, retailer, service provider, and the like. Therefore, if the consumer is currently viewing the web pages on another web site that is advertising the merchant's products, the consumer would have to terminate the connection to the host site to purchase the product from the merchant's site. This can be problematic if the consumer would like to continue viewing the host site before purchasing the product.

For example, the user can be conducting research on an important topic, viewing other products, reading media streams of news stories and the like. If the consumer sees an advertised product that the consumer desires to purchase, the consumer must either stop the current task to change web sites, or risk forgetting or losing the URL address to the merchant's site.

Consequently, a system and method are needed to solve the above-identified problems and provide a simple, efficient and cost-effective way to provide real time online product information and place electronic orders.

### SUMMARY

The present invention overcomes the aforementioned problems by providing an electronic advertising and purchasing system and method to enable a consumer to purchase or gain additional information about advertised products (e.g., goods or services) while the consumer remains connected to a hosting web site.

In an embodiment, a hosting server streams web pages from a hosting web site to a plurality of consumer workstations. The workstations include a browsing application that permits the consumer to view and interact with the web pages. The hosting server includes a sessions manager that controls the interactive browsing sessions. The hosting server also includes an ad generator that sends a banner applet to the consumer workstations to cause one or more promotional banners to be displayed on the web pages. The banners advertise one or more products sold by the merchants.

The banners contain links that are capable of being activated to send a request to the banner applet for additional product information, or for an order form to allow the consumer to purchase the advertised product. The banner applet supplies on-demand information to the consumer workstations without causing the workstations to query the hosting server, or to terminate or suspend their active sessions with the sessions manager. Thus, the consumer remains connected to the hosting web site.

An advantage of the present invention is that the merchants do not have to process product orders on their web sites. The orders are processed on the consumer workstations and sent to the merchants' server so that the order can be fulfilled. Therefore, the merchants are free to allocate their resources to provide additional services from their web sites.

A feature of the present invention is the ability of the consumer to remain connected to the hosting web site while the consumer places an order. Therefore, the consumer does not lose time or the consumer's place in or connection to the hosting web site, which generally occurs when one leaves a web site. As such, the consumer can continue browsing the web site after placing an product order with no interruption to the server connection.

### BRIEF DESCRIPTION OF THE FIGURES

The accompanying drawings, which are incorporated herein and form part of the specification, illustrate the present invention and, together with the description, further serve to explain the principles of the invention and to enable a person skilled in the pertinent art to make and use the invention. In the drawings, like reference numbers indicate identical or functionally similar elements. Additionally, the leftmost digit(s) of a reference number identifies the drawing in which the reference number first appears.

FIG. 1 illustrates a high-level block diagram of an embodiment of an electronic advertising and purchasing system.

FIG. 2 illustrates a high level relation diagram of an embodiment for generating instructions for a promotional banner.

FIG. 3 illustrates a block diagram of an example computer system useful for implementing the present invention.

FIG. 4 illustrates a block diagram of an embodiment of a diagram flow for a promotional banner and order form.

FIG. 5 illustrates a block diagram of a second embodiment of a diagram flow for a promotional banner and order form.

FIG. 6 illustrates a high-level operational flow diagram for the steps involved in generating and placing orders with multiple merchants from a common web site according to an embodiment of the present invention.

FIG. 7 illustrates a high-level operational flow diagram for the steps involved in generating and placing orders with multiple merchants from a common web site according to a second embodiment of the present invention.

### DETAILED DESCRIPTION

Table of Contents

| | |
|---|---|
| I. | Electronic Advertising and Purchasing System Overview |
| IIa. | Software and Hardware Embodiments |
| III. | Electronic Promotional Banners |
| IV. | Exemplary Electronic Advertising and Purchasing Sessions |
| V. | Conclusion |

I. Electronic Advertising and Purchasing System Overview

Electronic banners posted on a web page provide an convenient means for a merchant or vendor to promote its products (i.e., goods and services) to actual or potential consumers over a global computer network, such as the Internet. As such, merchants can enter into agreements with various individuals or entities (referred to herein as “affiliates”) to post the merchants' promotional banners or advertisements on the affiliates' web sites (referred to herein as “hosting web sites”). Generally, if the banners are posted on an affiliate's web site, the banners would contain a hyperlink or hype text that carries the consumer to another web site (typically, the merchant's web site), so that the consumer can purchase the advertised product. However, the methods and systems of the present invention enable the consumer to purchase or gain additional information about advertised products while the consumer remains connected to the hosting web site.

FIG. 1 illustrates, according to an embodiment of the present invention, system 100 for sending electronic advertisements and managing online purchases with a plurality of consumer workstations 101a-101n over a diverse computer network 110. Computer network 110 includes wired or wireless local area networks (LAN) and/or wide area networks (WAN), such as an organization's intranet, the global-based Internet or the like.

System 100 includes a sessions manager 115 and ad generator 120, which are applications (i.e., one or more routines and subroutines) operating on a hosting server 150 (“server 150”). Server 150 can be owned and operated by a merchant (i.e., manufacturer, retailer, service provider and the like) that is advertising and/or selling products from server 150. However, in the preferred embodiment, server 150 is owned and operated by an affiliate of the merchant. For example, server 150 can be operated by a dealer, distributor, associate or agent authorized by the merchant to promote the products. Server 150 can also be owned by a non-agent individual or entity who has agreed to promote the merchant's products.

Referring to FIG. 1, sessions manager 115 provides web pages from storage units (not shown) located within or connected to server 150. Sessions manager 115, therefore, commands and controls interactive browsing sessions with consumer workstations 101a-101n from the hosting web site. In an embodiment, sessions manager 115 is part of a multithreaded Java application that manages the interactive sessions with each consumer through a unique socket. Therefore, each consumer's session is managed by a respective thread in a Java application on server 150. Although the preferred embodiment of the present invention is described as a Java application, as would be apparent to one skilled in the relevant art(s), other programming languages (e.g., JavaScript, C, C++, and the like) can be used and are considered to be within the scope of the present invention.

The web pages, provided by sessions manager 115, contains promotional banners for various products. The products can be sold by one or more merchants. For example, an actual or potential consumer can use a consumer workstation 101a-101n to log onto computer network 110 to download web pages from a car dealer (i.e., hosting web site). In addition to text and/or graphical information about various automobiles, the web pages would also include one or more electronic banners promoting, for example, financing options from various banks (i.e., merchants). The banners contain links that enable the consumer to purchase or request additional information about the promoted services (e.g., automobile loans) or goods (as described in more detail below).

As shown in FIG. 1, sessions manager 115 communicates with ad generator 120 to support the interactive sessions. Ad generator 120 sends texts, graphics and other forms of media and multimedia that produces the promotional banners. Each banner can be an active banner that blinks, spins and the like, or the banner can be a passive banner that remains static on the browser application for the consumer workstation 101a-101n. The banner can also be a scrolling banner that includes a scroll bar that allows a consumer to move through contents of the banner. Resizeable banners can also be used to allow a consumer to expand or enlarge the banner to receive more data. The aforementioned is a representative list of banners that can be used with the present invention, it should be understood that any other type of banner capable of promoting a product, including, but not limited to, banners developed with Macromedia® Flash™ or Macromedia® Shockwave®, or the like, as would be apparent to one skilled in the relevant art(s), could be easily included and would not change the scope of the invention. Thus, any presently available or future developed banner advertisement that is responsive to a general purpose interface is encompassed by the present invention.

System 100 also includes one or more merchant servers 145a-145m. Each merchant that is promoting its products via system 100 would own or operate one or more merchant servers 145a-145m. The merchant servers 145a-145m are configured to receive and process an executed, electronic purchase orders from the banners distributed among consumer workstations 101a-101n. In an embodiment, merchant servers 145a-145m would provide periodic updates to server 150, at the discretion of the respective merchant. The updates would include new or additional goods or services, changes in the terms of offer (including price and delivery schedule) for the banners and the like.

Although FIG. 1 illustrates hosting server 150 and merchant servers 145a-145m as separate servers, the two servers in an embodiment can be the same. Hence, a merchant server 145a-145m can be configured to generate and route the banners of the present invention to consumer workstations 101a-101n, and receive electronic orders from the same. However, in the preferred embodiment, hosting server 150 merely advertises the product. As such, merchant servers 145a-145m are responsible for supporting the purchasing transactions with the consumer.

Each of hosting server 150 and merchant servers 145a-145m represents one or more computers providing various shared resources with each other and to the other network computers. The shared resources include files for programs, web pages, databases and libraries; output devices, such as, printers, plotters, display monitors and facsimile machines; and communications devices, such as modems and Internet access facilities. The communications devices can support wired and wireless communications, including satellite, terrestrial (fiber optic, copper, coaxial and the like), radio, microwave and any other form or method of transmission.

The servers are configured to support the standard Internet Protocol (IP) developed to govern communications over public and private Internet backbones. The protocol is defined in Internet Standard (STD) 5, Request for Comments (RFC) 791 (Internet Architecture Board). The servers can also support transport protocols, such as, Transmission Control Protocol (TCP). User Datagram Protocol (UDP) and Real Time Transport Protocol (RTP). The transport protocols support various types of data transmission standards, such as File Transfer Protocol (FTP), Hypertext Transfer Protocol (HTTP), Simple Network Management Protocol (SNMP), Network Time Protocol (NTP) and the like. The servers are also configured to support various operating systems, such as, Netware™ available from Novell®); MS-DOS®, Windows NT® and Windows® 3.xx/95/98/2000 available from Microsoft®; Linux(® available from Linux Online Inc.; Solaris™ available from Sun Microsystems, Inc.; and the like as would be apparent to one skilled in the relevant art(s).

FIG. 1 is a conceptual illustration of system 100 that allows an easy explanation of the present invention. That is, one or more of the blocks can be performed by the same piece of hardware or module of software. It should also be understood that embodiments of the present invention can be implemented in hardware, software, or a combination thereof. In such an embodiment, the various components and steps would be implemented in hardware and/or software to perform the functions of the present invention.

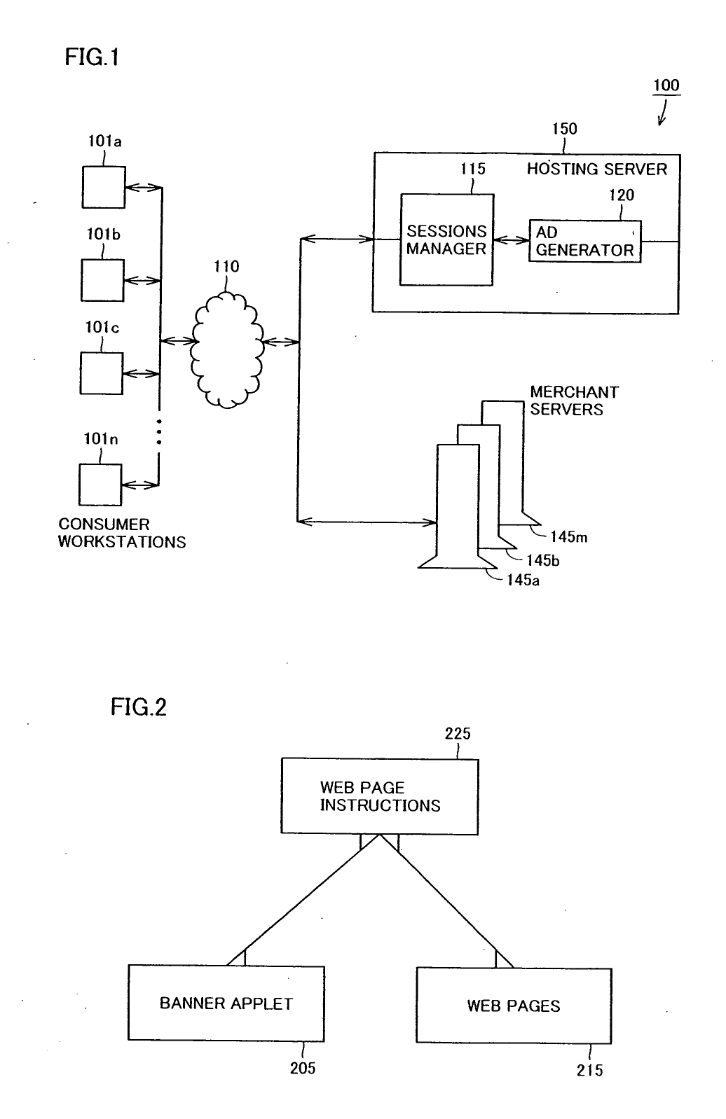

FIG. 2 illustrates an embodiment of a relational diagram for generating instructions for the banners of the present invention. As shown, banner applet 205 is integrated with a selected web page 215 to generate web page instructions 225. In an embodiment, banner applet 205 is formatted as a Java applet to produce a banner. Again, as discussed above, other programming languages could also be used. Thus, referring back to FIG. 1, when it is queried by sessions manager 115, ad generator 120 selects an advertisement, formats the advertisement to create banner applet 205 and forwards banner applet 205 to sessions manager 115. Sessions manager 115 integrates banner applet 205 into web page instructions 225 for generating the requested web page 215. Web page instructions 225 are sent by session manager 115 to the respective consumer workstation 101a-101n.

Banner applet 205 contains the instructions for generating one or more banners on a web page. The instructions include the text, graphics, audio, video and like media and multimedia used to generate the electronic banners. In an embodiment, banner applet 205 also includes instructions for providing additional information about the product that is being promoted. The additional information can include part numbers, prices, model, sizes, colors, delivery schedule, warranties, merchant's name, merchant's URL address, merchant's customer support address, telephone and facsimile numbers, and the like. The additional information can be presented in the form of text, graphics, audio, video, multimedia and the like. The additional information can be included automatically in the banner displayed on a consumer workstation 101a-101n, or it can be added when queried by the consumer.

Notwithstanding the instructions for additional information, banner applet 205 includes instructions for producing an order form on the browser application for a consumer workstation 101a-101n. In an embodiment, the order form is generated in response to a purchase request on a consumer workstation 101a-101n. After the consumer has completed the order form and sent a request to execute the electronic purchase order, banner applet 205 would also process and execute the order form on the local consumer workstation 101a-101n. Upon execution, banner applet 205 would send the electronic order to a designated merchant server 145a-145m.

Prior to being transmitted to the designated merchant server 145a-145m, the completed order form is encrypted to protect the transaction data. Thus, banner applet 205 is configurable to support data encryption and signature techniques, such as, Data Encryption Standard supported by the National Bureau of Standards, ANSI's Data Encryption Algorithm, public-key encryption introduced by Diffie and Hellman (D-H), the El Gamal (EG) public key system, RSA public keys developed by RSA Security Inc., DSA digital signature algorithm, and the like as would be apparent to one skilled in the relevant art(s). Moreover, in an embodiment, server 150 uses a secure sockets layer (SSL) to provide a secure data path for all communications with the consumer workstations 101a-101n.

Prior to execution, banner applet 205 processes the execution request to check for errors and completeness of the order form. In an embodiment, banner applet 205 contains instructions to confirm the consumer credit card information, if provided as the payment option, by contacting the consumer's bank. Communications with the consumer's bank is encrypted as discussed above. In an embodiment, banner applet 205 would create a confirmation message on the consumer workstation 101a-101n to permit the consumer to confirm the order prior to sending it to the merchant (i.e., merchant servers 145a-145m) and/or notify the consumer after the order has been sent to the merchant.

As described above, in an embodiment, banner applet 205 is integrated into web page instructions 225 by hosting server 150. In another embodiment, banner applet 205 is supplied by a third party server (not shown). In this embodiment, hosting server 150 prepares and sends web page instructions 225 to present the requested web page 215 with a banner advertisement. However, the banner advertisement would not contain the supporting files for executing a secured electronic purchase. The banner would contain a hyperlink to the third party server that supplies banner applet 205 on demand to the consumer. Upon activation of the hyperlink, the third party server would send banner applet 205 to the requesting client, whereupon banner applet 205 would provide the functionality described above to generate and execute a secured electronic purchase. Although a separate connection is established with the third party server to request and receive banner applet 205, the original connection with hosting server 150 would remain intact so that the consumer would not have to terminate the active session.

II. Software and Hardware Embodiments

The present invention (e.g., system 100. hosting server 150, sessions manager 115, ad generator 120, or any part thereof) can be implemented using hardware, software or a combination thereof and can be implemented in one or more computer systems or other processing systems. In fact, in an embodiment, the invention is directed toward one or more computer systems capable of carrying out the functionality described herein.

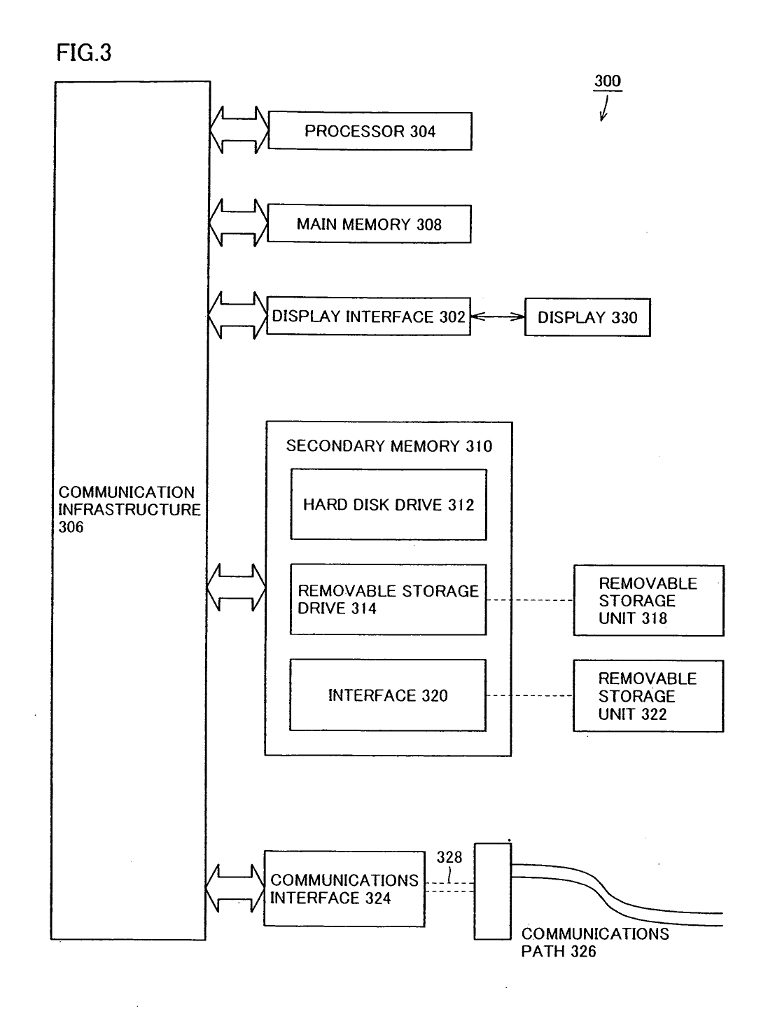

Referring to FIG. 3, an example computer system 300 useful in implementing the present invention is shown. The computer system 300 includes one or more processors, such as processor 304. The processor 304 is connected to a communication infrastructure 306 (e.g., a communications bus, crossover bar, or network). Various software embodiments are described in terms of this exemplary computer system. After reading this description, it will become apparent to a person skilled in the relevant art(s) how to implement the invention using other computer systems and/or computer architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and can also include a secondary memory 310. The secondary memory 310 can include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well-known manner. Removable storage unit 318, represents a floppy disk, magnetic tape, optical disk, etc. which is read by and written to removable storage drive 314. As will be appreciated, the removable storage unit 318 includes a computer usable storage medium having stored therein computer software and/or data.

In alternative embodiments, secondary memory 310 can include other similar means for allowing computer programs or other instructions to be loaded into computer system 300. Such means can include, for example, a removable storage unit 322 and an interface 320. Examples of such can include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to computer system 300.

Computer system 300 can also include a communications interface 324. Communications interface 324 allows software and data to be transferred between computer system 300 and external devices. Examples of communications interface 324 can include a modem, a network interface (such as an Ethernet card), a communications port, a PCMCIA slot and card, etc. Software and data transferred via communications interface 324 are in the form of signals 328 which can be electronic, electromagnetic, optical or other signals capable of being received by communications interface 324. These signals 328 are provided to communications interface 324 via a communications path (i.e., channel) 326. This channel 326 carries signals 328 and can be implemented using wire or cable, fiber optics, a phone line, a cellular phone link, an RF link and other communications channels.

In this document, the terms “computer program medium” and “computer usable medium” are used to generally refer to media such as removable storage drive 314, a hard disk installed in hard disk drive 312, and signals 328. These computer program products are means for providing software to computer system 300. The invention is directed to such computer program products.

Computer programs (also called computer control logic) are stored in main memory 308 and/or secondary memory 310. Computer programs can also be received via communications interface 324. Such computer programs, when executed, enable the computer system 300 to perform the features of the present invention as discussed herein. In particular, the computer programs, when executed, enable the processor 304 to perform the features of the present invention. Accordingly, such computer programs represent controllers of the computer system 300.

In an embodiment where the invention is implemented using software, the software can be stored in a computer program product and loaded into computer system 300 using removable storage drive 314, hard drive 312 or communications interface 324. The control logic (software), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

III. Electronic Promotional Banners

Referring again to FIG. 1 each consumer workstations 101a-101n can be a personal computer, personal digital assistant (PDA), telephone, television or like devices linked to computer network 110 and including a display device with the ability to place an electronic order. The display device for each consumer workstation 101a-101n provides a text or graphical user interface (GUI) and enables a potential or actual consumer to browse a media stream and interactively communicate with hosting server 150. The display provides graphical controls corresponding to various commands to hosting server 150.

In an embodiment of the present invention, each consumer uses a keyboard and/or mouse to interact with system 100 by manipulating the graphical controls of the display (e.g., buttons, scroll bars, links, and the like). In another embodiment, consumer workstations 101a-101n are configurable to receive verbal commands to execute various tasks during the interactive sessions. Using a rule-based expert system, a processing unit enables a voice recognition unit to identify the voice of the consumer to recognize and process verbal commands to activate the graphical control. Other input devices can be a mouse wheel, joystick, rudder pedals, touch screen, microphone, joystick, stylus, light pen, or any other type of peripheral unit. The aforementioned is a representative list of input devices that can be used with the present invention. It should be understood that any other type of input device, as would be apparent to a person skilled in the relevant art(s), could be easily included and would not change the scope of the invention. Any presently available or future developed device that is responsive to a general purpose interface is encompassed by the present invention.

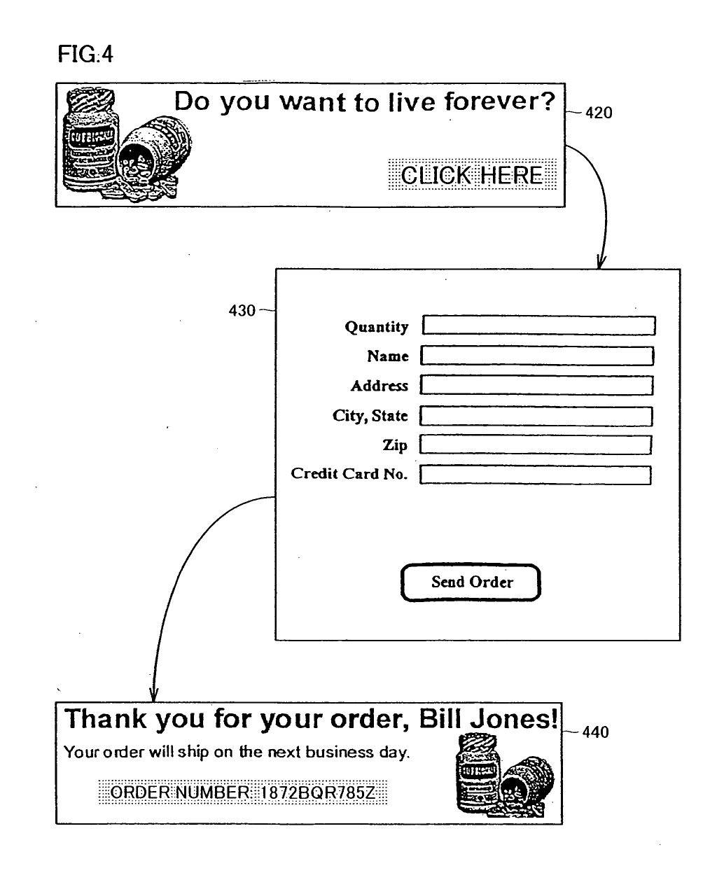

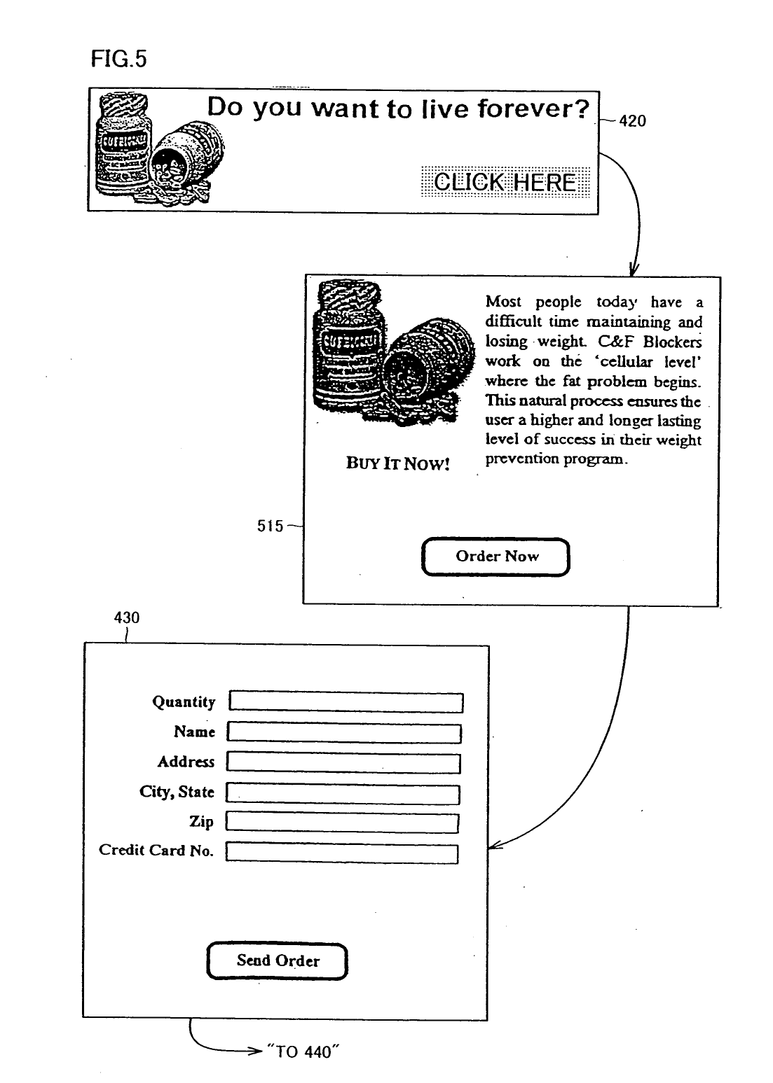

FIG. 4 illustrates an example of an electronic banner 420 sent to a consumer workstation 101a-101n from server 150. As discussed in reference to FIG. 1, electronic banner 420 promotes a merchant's product on a hosting web site. Electronic banner 420 can be a passive banner or an active banner (i.e., blinking, spinning, and the like). In an embodiment, ad generator 120 sends a banner applet to the consumer workstation 101a-101n to display electronic banner 420 on the workstations GUI. Using an input device, the consumer can activate a link within the banner (shown as “Click Here” in electronic banner 420) to purchase the advertised product. Activating the link would cause the GUI to display order form 430. In an embodiment, an application program interface (API) would interact with the input device and browser application to send a request to the resident banner applet order form 430. Banner applet 205 would, in turn, prepare and send instructions for the GUI for the consumer workstation 101a-101n to display order form 430. Order form 430 is prepared locally by the resident banner applet, and displayed as a separate window or frame such that the consumers current connection with the hosting web site is not terminated or suspended. After the consumer enters the appropriate data in the fields located on order form 430, the consumer can activate the link (shown as “Send Order”) within order form 430 to send a request to banner applet 205 to execute the electronic order. Once the order has been properly executed and forwarded to the appropriate merchant, banner applet 205 produces a confirmation banner 440, which is also displayed as a separate window such that the consumer's connection with the hosting web site remains intact.

FIG. 5 illustrates another example of an electronic banner 420. In this embodiment, activation of banner 420 sends a request to banner applet 205 for additional information. Banner applet 205 would, in turn, prepare and send instructions for the GUI to display banner 515. Banner 515 is an intermediary banner that contains additional promotional or descriptive data to aid the consumer in learning more about the product to facilitate a purchase decision. Banner 515 also contains a link (shown as “Order Now”). If the consumer activates the link in banner 515, a request would be sent to banner applet 205 for order form 430 as discussed above.

As would be apparent to one skilled in the relevant art(s), banner 515 is only an example of an intermediary banner. In fact, the number and types of banners or windows that can be generated to be displayed as intermediary banners between banner 420 and order form 430 can vary and would not change the scope of the present invention. For example, activating the link in banner 420 can generate a plurality of sub-banners, each promoting a separate product or providing supporting data for a product referenced in banner 420. Activating the sub-banners can generate other sub-banners to promote other products or provide supporting data for the promoted products.

IV. Exemplary Electronic Advertising and Purchasing Sessions

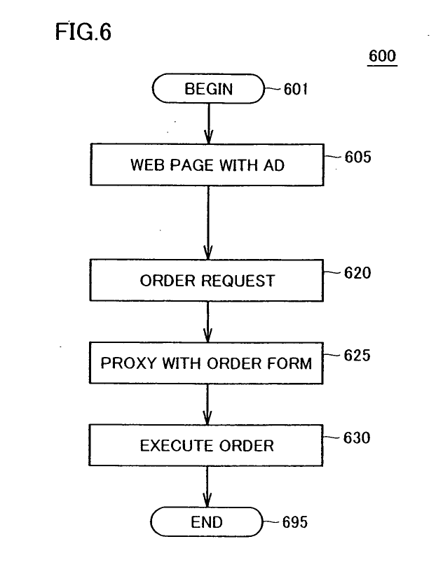

Referring to FIG. 6, flowchart 600 represents the general operational flow of an embodiment of the present invention. More specifically, flowchart 600 shows an example of a control flow for sending promotional banners and executing electronic orders over a computer network 110.

Referring to FIG. 6, the control flow of flowchart 600 begins at step 601 and passes immediately to step 605. At step 605, an actual or potential consumer, using a consumer workstation 101a-101n, visits a hosting web site in communications with server 150. Sessions manager 115 initiates an interactive session with the consumer by streaming a web page containing one or more electronic banners 420. Each electronic banner 420 promotes a good or service provided by a merchant owning or operating one or more merchant servers 145a-145m. To generate the web page on the consumers browser, sessions manager 115 sends web page instructions 225 which contains banner applet 205. Banner applet 205 manages all consumer interactions with electronic banner 420 while banner applet 205 resides locally on the consumer workstation 101a-101n. Thus, the consumer would not have to terminate or suspend the connection to session manager 115.

At step 620, the consumer expresses an interest in purchasing the promoted good or service and activates a link in banner 420. The link sends a request to banner applet 205 for an order form. At step 625, banner applet 205 receives the purchase request. As discussed above, server 150 is designed to enable the consumer to maintain the current connection to the hosting web site without having to be transferred to a merchant's web site to purchase the merchant's products. As such, banner applet 205 remains dormant or lurking until the consumer sends the purchase request. Banner applet 205 functions as a proxy for the actual merchant servers 145a-145m. In an embodiment, the practical extraction and report language (PERL) is used to implement this proxy application. Since banner applet 205 is a proxy application, the consumer, in an embodiment, would receive a warning message before any product information (including order form 430) is displayed on the consumer workstation 101a-101n. As such, in this embodiment, banner applet 205 implements instructions to create a dialog box on the GUI for consumer workstation 101a-101n. The dialog box would request the consumer's authorization to proceed with the transaction. If the consumer provides the authorization, banner applet 205 would implement instructions to display order form 430. In another embodiment, banner applet 205 would display the order form 430 without seeking or obtaining the consumer's authorization.

At step 630, the consumer would use an input device to complete order form 430. After the consumer has completed order form 430, the consumer would activate the link with order form 430 to send a request to banner applet 205 to execute the order. Banner applet 205 confirms order form 430 for completeness and forwards the data to the appropriate merchant server 145a-145m. In an embodiment, consumer authorization is secured prior to sending the order form to the appropriate merchant server 145a-145m. In another embodiment, consumer authorization is not requested or secured. In an embodiment, confirmation banner 440 is sent to notify the consumer that the electronic order has been properly placed. At this point the interactive session terminates and the control flow ends as indicated by step 695.

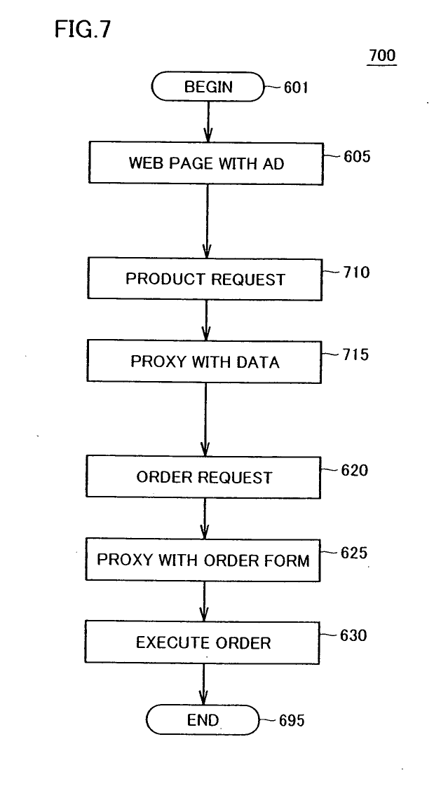

Referring to FIG. 7, flowchart 700 represents the general operational flow of a second embodiment of a control flow for sending promotional banners and executing electronic orders over a computer network 110.

Referring to FIG. 7, the control flow of flowchart 700 begins at step 601 and passes immediately to step 605. Step 605 is identical to the process step in control flow 600. After step 605, control flow 700 begins to differ from the embodiment described in control flow 600. At this point, control flow 600, passes to step 710. At step 710, when a consumer activates the link in banner 420, a product request is sent to banner applet 205 for additional information. At step 715, banner applet 205 receives the purchase request. As described, banner applet 205 is a proxy application and, in an embodiment, sends instructions to seek the consumer's authorization before responding to the product request. If the consumer provides the authorization, banner applet 205 would send instructions to display banner 515. Steps 620-695 are identical to the process steps in control flow 600. As such, the control flow ends as indicated by step 695.

V. Conclusion

It should be understood that the term “hosting web site” can be the merchant's web site as well as an affiliate's web site. Any individual merchant can also own or operate hosting server 150. For example, a first server (i.e., server 150) can provide specific information or services to the consumer, but the web pages from the first server 150 would have banners promoting other (similar or unrelated) products that are sold on a second server 145a-145m. In this embodiment, the consumer can activate the banners to purchase the similar products from the second server 145a-145m without having to suspend or terminate the connection with the first “hosting” server 150.

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus, the present invention should not be limited by any of the above described exemplary embodiments, but should be defined only in accordance with the following claims and their equivalents.

What is claimed is:

1. A system for placing electronic orders, comprising:
a sessions manager to send instructions from a hosting server to a data processing unit over a computer network, said instructions causing said data processing unit to display web pages from a hosting web site during an interactive session between said data processing unit and said hosting server; and
an ad generator to produce a banner applet, said banner applet integrated with said instructions to present on said web pages one or more advertised products provided by one or more merchants,
wherein said banner applet comprises instructions to cause said data processing unit to present an order form in response to a purchase request to purchase an advertised product without having to exchange additional communications with said hosting server, and
wherein said sessions manager continues said interactive session so that said hosting server remains connected to said data processing unit while a user operates an input device in communication with said data processing unit to complete said order form.

2. A system of claim 1, wherein said banner applet further comprises instructions to cause said data processing unit to present descriptive information related to said advertised product in response to a descriptive information request, wherein said descriptive information includes an option to send said purchase request.

3. A system of claim 1, wherein said banner applet processes said order form in response to instructions from the user to send said order form to said merchant to thereby generate an electronic order without having to exchange additional communications with said hosting server.

4. A system of claim 3, wherein said order form is encrypted prior to being transmitted to said merchant.

5. A system of claim 3, wherein said banner applet exchanges communications with a second server to confirm billing information entered into said order form by the user prior to transmitting said order form to said merchant.

6. A system of claim 3, wherein said banner applet further comprises instructions to cause said data processing unit to present an authorization request, wherein said order form is generated or processed in response to the user indicating a positive response to said authorization request.

7. A system of claim 1, wherein said computer network includes the global Internet.
